(19) United States
(12) Patent Application Publication
(10) Pub. No.: US 2005/0166137 A1
(43) Pub. Date: Jul. 28, 2005

(54) Systems and methods for analyzing documents

(76) Inventor: Bao Tran, San Jose, CA (US)

Correspondence Address: TRAN & ASSOCIATES, 6768 MEADOW VISTA CT., SAN JOSE, CA, 95135, US

(21) Appl. No.: 10/764,647

(22) Filed: Jan. 26, 2004

(51) Int. Cl. G06F 17/00

(52) U.S. Cl. 715/501.1; 715/513; 382/321

(57) ABSTRACT

An electronic document having first, second and third portions is generated by embedding one or more links in the first portion referencing one or more external documents viewable using a viewer application and embedding one or more links in the third portion referencing information contained in the second portion.

### BACKGROUND

Rapid advances in new ideas are revolutionizing today's modem economy. The new ideas are described in documents, which are becoming more complex. For example, technical documents such as scientific publications and engineering specifications demand precision in drafting and reviewing. Other complex documents include contracts and agreements. Yet other difficult documents to draft and to review include patent applications, which eventually issue as patents.

A patent is a government grant formalized by an official document issued by a national patent office, including the US Patent & Trademark Office (USPTO), the European Patent Office (EPO), and the Japanese Patent Office (JPO), among others. By law, a patent has the attributes of personal property. The patent system has constitutional roots and is intended to promote the advancement of science and the useful arts. This advancement is promoted by granting limited exclusive rights to inventors in return for public disclosure of inventions. Public disclosure encourages scientific and technological advancement. In exchange for the public disclosure, the owner of a patent has the right to exclude others from making, using or selling the “patented invention” in the US, its possessions and territories. This right is enforceable against those who reverse engineer or independently develop the patented invention.

An individual may wish to study a patent for a variety of reasons. For example, once the individual has been made aware of a patent that may cover his or her product, the individual is under a duty to study the patent and cease making the product if it infringes. In other cases, the individual may wish to study the patent to better understand the prior art. In yet other cases, for expired patents, the individual may want to practice the patented invention.

A particular patent can be located on-line: major patent offices such as the USPTO, the EPO and the JPO provide search engines to perform text search. Alternatively, an individual may become aware of a particular patent number printed on a box for a patented product, or the individual may have heard news about a particular company's patent claims.

To retrieve a copy of a particular patent, a user can print pages one at a time from the patent offices' web sites. Alternatively, the user can order a patent from various suppliers. The user can use software that essentially downloads each page image of a patent and consolidates the page images into a single file for reviewing. The user can also subscribe to various patent suppliers. For example, Rapidpat sells searchable copies of individual patents as well as Digital Libraries that enable instant access to the documents of patent portfolios. Searchable, compressed image documents, prior art, and other data collections are integrated as one digital collection.

The document can be provided as a PDF document. PDF is sometimes referred to as Acrobat files. PDF files can be created from other electronic files by converting the data into Postscript. Hardcopy PDF conversion can be performed as well by scanning images and converting files into one of three PDF types. PDF is easily accessible across multiple platforms (PC, MAC, UNIX, LINUX). PDF provides strong copyright protection, is web ready and looks exactly like the originals. PDF documents can be secured to prevent alterations, printing or any type of annotation. PDF is the de facto standard for electronic distribution of documents because it is the best way to keep the look and feel intact. PDF files are compact, cross-platform and can be viewed by anyone with an Acrobat Reader. PDF files can be distributed globally via e-mail, the Web, corporate intranets, or CD-ROM. Acrobat Reader's navigation and zoom features enable closer review of PDF file text and images, even within a browser. PDF files can be easily viewed and printed a page at time. Links, annotations, live forms, security options, video, and sound can be added to PDF files for enhanced online viewing with Adobe Acrobat.

After getting a copy of the patent, the real work begins. Unless the reader is highly experienced with patents, reading and understanding the scope of a particular patent can be a painful undertaking. This is because a patented invention is defined by the claims which define the boundaries of an invention much like the description of property in a deed defines the boundaries of real estate. To determine precisely the “metes and bounds” of a patented invention, however, the patent specification, drawings, file history and “prior art” must also be reviewed. In general, unless litigation is anticipated, the patent is analyzed without the file history.

### SUMMARY

An electronic document is disclosed with first, second and third portions. The document is generated by embedding one or more links in the first portion referencing one or more external documents viewable using a viewer application and embedding one or more links in the third portion referencing information contained in the second portion.

Advantages of the invention may include one or more of the following. The annotated document is easier to interpret since relevant information is parsed and visually provided to the user. Further, external information such as information from external documents and file history can be incorporated to ease interpretation.

### BRIEF DESCRIPTION OF THE DRAWINGS

FIG. 1 illustrates an exemplary environment with a document in accordance with one inventive system.

FIG. 2 illustrates an exemplary flow-chart.

FIG. 3 illustrates an exemplary document format.

FIG. 4 illustrates an exemplary annotation of the drawings or the claims of a patent document.

### DESCRIPTION

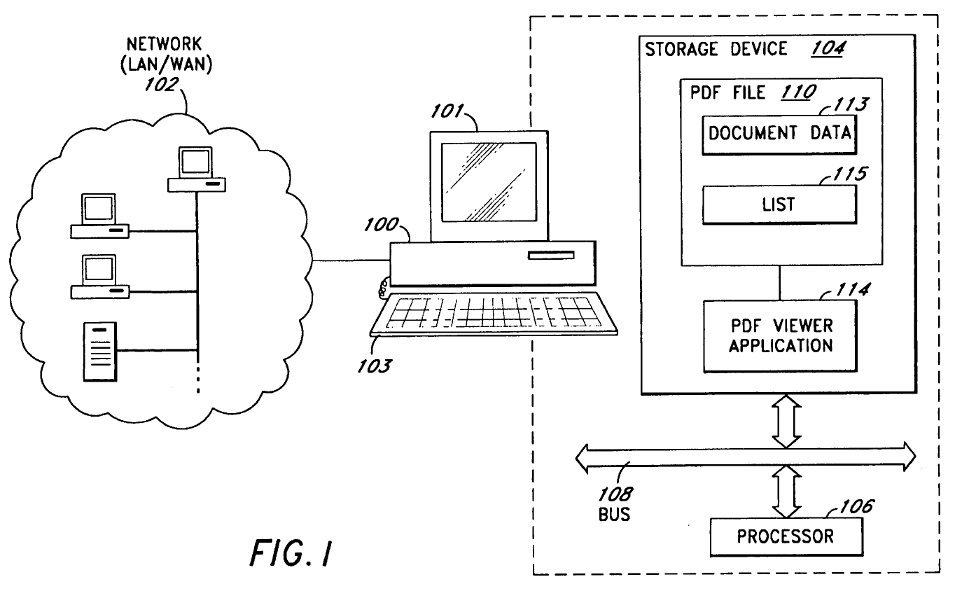

FIG. 1 illustrates an embodiment of a computer system with the method and apparatus of the present invention. A computer 100 has a display device, such as a monitor 101 and an input device, such as a keyboard 103. In one embodiment, the computer 100 may be coupled to a network 102 such as a local area network (LAN) or a wide area network (WAN). The network 102 is a possible mechanism for distribution of intellectual property (IP) related documents.

The computer 100 has a storage device 104 coupled to a processor 106 by a bus or busses 108. The storage device 104 has a document data 13 and one or more links 115 that provides additional information on the document data. The links 115 contains embedded information referencing one or more external documents viewable using a viewer application and information summarized from different section(s) or portion(s) of the document 13. In one embodiment, the link 115 is associated with the document 13 and is contained within the document 113.

The document 13 may be viewed through a viewer application 114 providing a graphical user interface (GUI). The links are programmatically enforced by the viewer application. In an alternate embodiment, the document 13 may be any type of electronic data.

In one embodiment, the document 113 is a portable document format (PDF). In this embodiment, the storage device 104 has a PDF file 110 that encapsulates the links 115. PDF is a file format utilized to represent a document in a manner independent of the application software, hardware and operating system used to create it. A PDF writer application converts operating system graphics and text commands to PDF operators and embeds them in a PDF file. The PDF files generated are platform independent and may be viewed by a PDF viewer application on any supported platform. Document data 113 in a PDF file 110 contains one or more pages, each page in the document containing a combination of text, graphics and images. Document data 113 may also contain information such as hypertext links, sound and movies. The recipient list 115 contains a list of recipients allowed access to the PDF file 110 document data 113.

The PDF file 110 may be browsed or viewed through a PDF viewer application 114 providing a graphical user interface (GUI). PDF viewer application 114 may be Adobe Acrobat Exchange or Acrobat Reader applications, both made available by Adobe Systems, Inc. of San Jose, Calif.

The file can receive permission attributes into the list 115 of links. The permission attributes identify varying levels of access to data contained in the PDF file 110 as provided to each recipient listed in the list 115. The PDF viewer application 114 accesses the permission attributes embedded in the list of links 115 to determine the level of access permission of a given recipient to a given PDF file 110. The permissions are programmatically enforced by the PDF viewer application 114.

The remainder of the detailed description will be described in reference to the preferred embodiment of the present invention illustrated in FIG. 1. However, it can be appreciated by a person skilled in the art that other equally applicable embodiments may be derived given the detailed description provided herein.

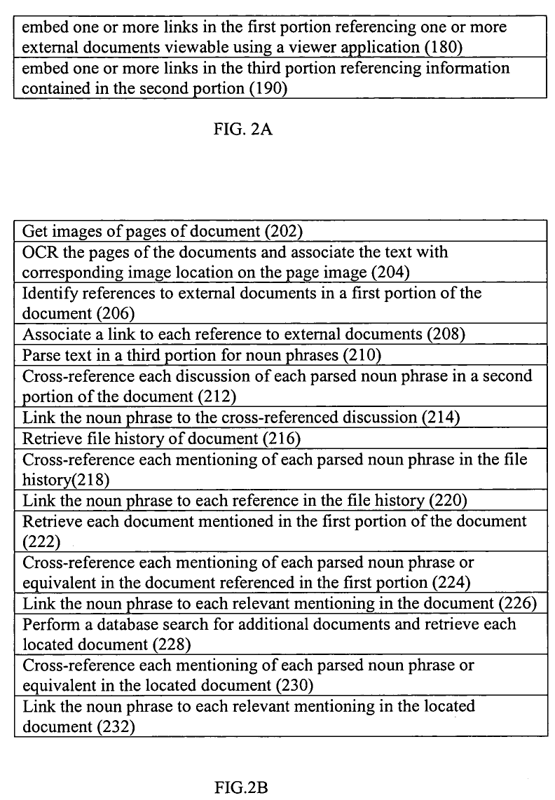

FIG. 2A shows one exemplary process for generating an electronic document in accordance with the invention. The process of FIG. 2A provides an electronic document having first, second and third portions by embedding one or more links in the first portion referencing one or more external documents viewable using a viewer application (180); and embedding one or more links in the third portion referencing information contained in the second portion (190).

In one embodiment, major structure of the document is shown in an outline that can be selected for quick navigation. Thus, a typical document may have an introduction section, a background section, drawings, description of the drawings, among others. The major structures are outlined and the user can easily navigate the document.

In one embodiment, if external documents are referenced, the links referencing external documents can be clicked upon by a user, and a new window opens and the external document is displayed. The link to the external document may be an identifier that can be searched and located from the Internet in one embodiment.

In another embodiment, the links in the third portion can be a link that points back to text in the second portion. When clicked, the user is taken to the appropriate text in the second portion. Alternatively, the links can be shown as PDF comments and/or bookmarks that can be used to navigate to the links.

In another embodiment, a summary of specific items mentioned in the document can be generated. The document may recite a number of items, for example a parts list and due to the numerosity, a summary list for the items may be useful for a reviewer to view. The summary can be placed in the PDF comment section or the PDF bookmark section, among others. When clicked, the user is transported to view the relevant section that mentions, refers, or discusses the item in the summary list.

In yet another embodiment, a navigation bar is provided to allow the user to move to the next item (forward), to go back to the previous item (backward), to go to the beginning (start), to go to the last section (end), or to fast forward and fast reverse, among others. Thus, using the summary list example, the user can use the navigation bar to navigate from the first mentioning of the item to the next mentioning of the item until the end is reached. Similarly, using the reference from the second portion that is mentioned in the third portion, the user can use the navigation bar to navigate the first mentioning of a particular term in the second portion. The user can move to the next mentioning of the term or the previous mentioning of the term.

FIG. 2B shows an exemplary process to generate the document 113 of FIG. 1. First, the process retrieves images of pages of document (202). Next, the process performs optical character recognition (OCR) on the pages of the documents and associates the text with corresponding image location on the page image (204). References to external documents in a first portion of the document are identified (206), and a link to each reference to external documents (208) is generated. With this link, a user can simply click on the title or any suitable mentioning of the external document and the external document will be retrieved and displayed for user review.

Next, the process of FIG. 2B parses text in a third portion for terminology such as text or noun phrases, among others (210). In one embodiment, the process cross-references each discussion of each parsed noun phrase in a second portion of the document (212). The process then links the noun phrase to the cross-referenced discussion (214). In this manner, the process shows consistent and/or inconsistent references to noun phrases in the third portion so that a user can quickly understand potential ambiguities in the document. Items mentioned in the drawings can also be cross-referenced.

In an optional operation, the process of FIG. 2B retrieves a file history of the document (216). The process then cross-references each mentioning of each parsed noun phrase in the file history (218). The noun phrase is linked to each reference in the file history (220). By showing the references to the noun phrases in the file history, the process shows consistent and/or inconsistent references to noun phrases in the third portion so that a user can quickly understand potential ambiguities in the document.

In yet another optional operation, the process of FIG. 2B retrieves each document mentioned in the first portion of the document (222). Each mentioning of each parsed noun phrase or equivalent in the external document is cross-referenced to the corresponding text in the first portion (224). The process then links the noun phrase to each relevant mentioning in the document (226). In this manner, the process of FIG. 2 identifies relevant references to the instant document from the external documents.

In another optional operation, the process performs a database search for additional documents and retrieves each located document (228). The search may locate data over the Internet or may locate data over an Intranet. The process cross-references each mentioning of each parsed noun phrase or equivalent in the located document (230) and links the noun phrase to each relevant mentioning in the located document (232). In this manner, the process of FIG. 2B identifies additional relevant references to the instant document by performing one or more searches.

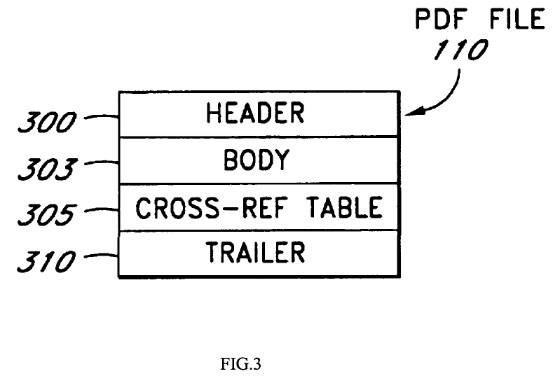

FIG. 3 illustrates an embodiment of the PDF file 110 file structure. A header 300 specifies the version number of the PDF specification to which the PDF file 110 adheres. A body 303 of a PDF file 110 consists of a sequence of indirect objects representing a document. The objects represent components of the PDF document, such as fonts, pages and sampled images. A cross-reference table 305 contains information which permits random access to indirect objects in the PDF file 110, such that the entire PDF file 110 need not be read to locate any particular object. Finally, a trailer 310 enables an application reading a PDF file 110 to quickly find the cross-reference table and to locate special objects.

The PDF file can be generated using a variety of tools such as SDKs from Adobe and Tracker Software. In one embodiment, Tracker Software's PDF-XChange is used. The tool allows the user to append to an existing PDF file (job management is now available & significantly improved); mount multiple source pages on a single output page; output to resolutions of up to 2400 DPI, varied paper sizes (PDF-Xchange supports the 42 most used paper formats +100 forms sizes may be added by the user, DPI now may be not only chosen from the standard list, but also set up manually in the wide range of 50-2400 dpi); manage embedded fonts; work with CJK fonts (PDF-XChange V3 supports fonts containing Unicode symbols for users requiring Chinese, Japanese and Korean (CJK) font compatibility.); design and add watermarks to the output; recognize/create bookmarks automatically; send created PDF documents immediately via e-mail using the internal built-in mailer (SMTP) or call the default system mailer (MAPI)—such as MS Outlook; save files to automated ‘Macro’ based file names and locations; call a viewer or software application after the file is created; create and use profiles to set the environment and setting according to different needs; and use Hot web URL links which are supported.

Next, an exemplary operation of an exemplary embodiment to generate a smart patent PDF file is discussed. In this embodiment, images of patent pages are retrieved. The images can be pulled from a proprietary database or can be pulled from various government web sites such as the USPTO (www.uspto.gov), the EPO (www.epo.org), the Korean Patent Office (www.kipo.go.kr), or the JPO (wwwjpo.go.jp), or the Chinese State Intellectual Property Office (http://www.sipo.gov.cn) for example. The image of each page is OCRed and the resulting patent text is associated with corresponding image location on the page image.

In one embodiment, the patent images can be downloaded over the Internet. Alternatively, an original can be converted. The PDF Image and Searchable Text Conversion (formerly known as PDF plus hidden text) file contains a bitmapped image of the original, and a hidden layer of searchable text. The conversion process involves: scanning the hardcopy original, performing OCR (Optical Character Recognition) to capture the text of the document, and distilling the two layers into a PDF searchable image file. Though text can be searched, hyperlinks and bookmarks are not fully functional in this format. As with PDF image only, PDF searchable image files are only as legible as the original.

Alternatively, instead of OCRing the text, the patent number can be extracted, a search can be made at the corresponding government patent web site to locate the patent record. The patent record is in HTML or XML format, and the various portions of the patent can be separated and indexed. Then, text can be parsed and associated with the PDF document. The association can be position independent or dependent. In position independent embodiment, the location of the text is not aligned with its corresponding image location in the patent image. In position dependent embodiment, the location of the text is aligned with its corresponding image location in the patent image.

The process of can also search for matching claim phrases in external documents listed in a first portion of the patent (known prior art). Text in the known prior art is searched for noun phrases (or equivalent thereof) in the claims. Equivalency can be determined by looking up synonyms in a thesaurus, for example. Other ways of determining equivalency can be used as well. For example, from a corpus set of training patents, if certain words are statistically correlated and are likely to appear with other words, these words are considered to be equivalent and the search terminology can be expanded to include the original words as well as the equivalent words. The process cross-references each discussion of each parsed noun phrase in the external documents and links the words to the cross-referenced discussion. A similar process is performed for the file history of the patent being analyzed. Words that are important in construing the claims based on the file history are then identified for easy review. In addition to the file history, the system can perform a search for other prior art. The search can be carried out using a suitable search engine such as Google, for example, or can be carried out using the patent office search engines, among others. Each pertinent prior art found in the search is retrieved and links from the claim text are made to the newly located prior art.

In one embodiment, the process annotates drawings for user review. This is done by taking the item or part list which has been generated and associating the corresponding item name with the item number. Conversely, if the drawing mentions the item name but not the item number, the drawing can be annotated with the item number. As a result, the review or interpretation of the patent document can be made efficiently by avoiding manual annotation.

In yet another embodiment, the drawings can be annotated with the claim language. Since the user can comprehend images or drawings much faster than text, such annotation of the drawings can enhance review efficiency.

In yet another embodiment, the drawings can be annotated with citations to relevant prior art for ease of identifying novelty. In yet another embodiment, the citations to relevant prior art can be noted along with citations to the claim language.

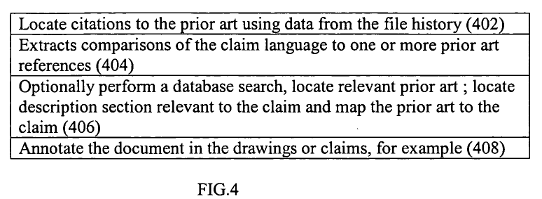

FIG. 4 illustrates an exemplary annotation of the drawings or the claims of a patent document. The process locates citations to the prior art using data from the file history (402); extracts comparisons of the claim language to one or more prior art references (404); and optionally performs a database search, locate relevant prior art ; locate description section relevant to the claim and map the prior art to the claim (406) Annotate the document in the drawings or claims, for example (408). The citations to the prior art can be done using data from the file history. In this embodiment, the process extracts comparisons of the claim language to one or more prior art references. Each comparison is noted on the document. Alternatively, the process can perform a database search, locate relevant prior art, and annotate the document appropriately. The database search can be a linguistic search that searches for the terminology, for the concepts, or a combination of both. The linguistic search can also be done using one or more languages such as English, Germany, Japanese, or Chinese, among others.

Although the foregoing relates to an issued patent document, the same can be applied to pending applications as well. Also, the analysis process and embedding of information are applicable to a number of patent offices including the USPTO, EPO, JPO, and KIPO, among others. Further, although PDF is mentioned as one embodiment, other document formats are contemplated. Examples of such document formats include Microsoft's XDoc, HTML documents, XML documents, TIFF documents, JPEG documents, and multimedia documents, among others. XDocs (InfoPath) is Microsoft's new XML-based forms and document solution. XDocs is optimized for the Microsoft Office System, picture it as an ecosystem that represents a combination of familiar and easy-to-use programs, servers and services that are intended to help information workers address a broader array of business challenges. It encompasses the core Microsoft Office client applications, as well as FrontPage 2003, Visio 2003, Project 2003 and Publisher 2003, as well as new desktop applications, InfoPath 2003 and OneNote 2003. With the addition of servers, such as SharePoint Portal Server 2003, Project Server 2003 and the Live Communications Server 2003, users will be able to take advantage of deeper collaboration capabilities and communication tools like live chats within familiar productivity applications right from their PCs.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

1. A method for providing an electronic document having first, second and third portions, comprising:
embedding one or more links in the first portion referencing one or more external documents viewable using a viewer application; and
embedding one or more links in the third portion referencing information contained in the second portion.

2. The method of claim 1, wherein said document is a portable document format (PDF) document residing in a PDF file.

3. The method of claim 2, comprising encapsulating said one or more links into said PDF file.

4. The method of claim 1, wherein said viewer application is a PDF viewer application.

5. The method of claim 1, comprising retrieving one or more pages of an external document referenced by a link in the first portion and consolidating all pages into the external document.

6. The method of claim 1, wherein the electronic document comprises a patent or a patent application and wherein the first portion comprises a prior art section, the second portion comprises a description section, and the third portion comprises a claim section, comprising cross-referencing an element in the claim section against one or more references to the element in the specification section.

7. The method of claim 6, comprising cross-referencing the element in the claim section against one or more references to the element in the one or more external documents.

8. The method of claim 6, comprising visualizing one or more claims in a tree view.

9. The method of claim 8, further comprising drilling down details of each claim in the tree view.

10. The method of claim 6, further comprising retrieving a file history for the patent or the patent application and cross-referencing the element in the claim section against one or more references to the element in the file history.

12. The method of claim 6 or 7, further comprising cross-referencing the element against equivalent terminology for the element in the specification section or in the one or more external documents.

13. The method of claim 1, comprising searching a database for related external documents.

14. The method of claim 13, wherein the database is located on the Internet.

15. The method of claim 13, wherein the electronic document comprises a patent or a patent application and wherein the first portion comprises a prior art section, the second portion comprises a description section, and the third portion comprises a claim section, further comprising cross-referencing an element in the claim section against one or more references to the element in the one or more related external documents.

15. The method of claim 13, comprising mapping intellectual property for an industry covered by the patent or the patent application.

16. The method of claim 1, comprising generating text using optical character recognition (OCR) from an image of a page of the document and associating the text with the corresponding location of the text in the image.

17. The method of claim 16, wherein the document is text searchable PDF document.

18. The method of claim 1, comprising saving user annotation in the document.

19. An apparatus for providing an electronic document having first, second and third portions, comprising:
one or more links embedded in the first portion referencing one or more external documents viewable using a viewer application;
one or more links embedded in the third portion referencing information contained in the second portion.

20. A system for providing access to a document stored in a computer-readable medium and executable by a computer, comprising:
one or more links embedded in the first portion referencing one or more external documents viewable using a viewer application;
one or more links embedded in the third portion referencing information contained in the second portion.

21. A computer readable media containing executable computer program instructions which when executed on a digital processing system causes the system to perform a method comprising:
embedding one or more links in the first portion referencing one or more external documents viewable using a viewer application; and
embedding one or more links in the third portion referencing information contained in the second portion.
